(19) United States
(12) Patent Application Publication
(10) Pub. No.: US 2018/0126533 A1
(43) Pub. Date: May 10, 2018

(54) Combined Integral Chisel having High Efficiency

(71) Applicant: HANGZHOU ZHONGJIE TOOLS CO.,LTD., Hangzhou (CN)

(72) Inventors: Jianping TANG, Hangzhou (CN); Linglin FU, Hangzhou (CN); Zhongejie FU, Hangzhou (CN)

(73) Assignee: HANGZHOU ZHONGJIE TOOLS CO.,LTD., Hangzhou (CN)

(21) Appl. No.: 15/730,718

(22) Filed: Oct. 11, 2017

(30) Foreign Application Priority Data
Nov. 4, 2016 (CN) 201610962980.2

(51) Int. Cl. B25D 3/00; B25G 1/01; B25G 1/10

(52) U.S. Cl. CPC B25D 3/00; B25G 1/102; B25G 1/01

(57) ABSTRACT

The invention relates to an integral chisel, and more particularly to a combined integral chisel having high efficiency, including a main body. A head portion of the main body is a chisel head portion, an end portion of the main body is a grab handle portion. The chisel head, the main body and the grab handle portion are integrally distributed. The combined integral chisel having high efficiency has advantages of compact structure, excellent performance, and improved operational safety performance.

### CROSS REFERENCE TO RELATED APPLICATIONS

This application is based upon and claims priority to Chinese Patent Application No. 201610962980.2, filed on Nov. 4, 2016, the entire content of which is incorporated herein by reference.

### TECHNICAL FIELD

The present invention relates to an integral chisel, particularly to a combined integral chisel having high efficiency.

### BACKGROUND

The holding handles of traditional single chisels are limited by the rod diameters, and have shapes like hexagonal, octagonal, quadrilateral or oval, etc. The shapes are rigid, and the holding handles have poor grip, without shock absorption function. When using the chisel to knock, the chisel with a strong shock makes the operations very unstable and easy to slip. As to the traditional chisel with a grab handle, since the handle and iron piece are installed by compressing, there is no stable fixing design. Thus, during a long period of use, the handle will slowly become loose, resulting in sliding up and down, which greatly affects the operational stability.

### SUMMARY OF THE INVENTION

The present invention is mainly to solve the deficiencies existing in the prior art. The present invention provides a combined integral chisel having high efficiency, which has a compact structure, a design fitting the hand. And the grab handle and main body of the present invention are provided with shock absorption function.

The above technical problems of the present invention are mainly solved by the following technical solutions:

A combined integral chisel having high efficiency, includes a main body. A head portion of the main body is a chisel head portion, an end portion of the main body is a grab handle portion. The chisel head portion, the main body and the grab handle portion are integrally distributed.

The outer end of the chisel head portion is a chisel head.

Preferably, the chisel head portion is divided into a wide chisel and a point chisel, the angle of the chisel head is within 30 degrees to 90 degrees.

The end of the grab handle portion is provided with a shock absorbing hole, and two sides of the grab handle portion are respectively provided with a plurality of finger grooves.

Preferably, the grab handle portion is provided with a pair of plastic handle mounting holes spaced from each other. The plastic handle mounting plates are respectively arranged at a top portion and a bottom portion of the grab handle portion, and the two plastic handle mounting plates are assembled and positioned by the plastic handle mounting holes.

The end of the grab handle portion is a protective ring mounting portion, and the protective ring mounting portion is provided with a protective ring.

Preferably, the end of the plastic handle mounting plate is provided with a shock absorbing through hole, wherein the shock absorbing through hole is connected to the shock absorbing hole. The protective ring is assembled by two semicircular protective sheets, wherein a diameter of the protective ring is bigger than a width of the grab handle portion, and the two plastic handle mounting plates are fixed to the grab handle portion by bolts.

Preferably, a surface of the plastic handle mounting plate is a soft material, an interior part of the plastic handle mounting plate is hard material.

Preferably, the grab handle portion is provided with a mounting slot for the plastic handle mounting plate, and the plastic handle mounting plate is embedded into the mounting slot for the plastic handle mounting plate.

The integral chisel is prepared by the following steps:

(1) Blanking:

The name of the required equipment: steel bar cutting machine: required fixture tool: cutting-off die;

Specific operations: The cutting-off die with a corresponding size is installed on the steel bar cutting machine, and the backing location is adjusted according to size requirments. And then, starting the device, the profile is inserted into the cutting-off die, against the backing. The steel bar cutting machine automatically cuts the profile off, by this way, to obtain the required material length.

(2) Pier:

The name of the required equipment: heating equipment and puncher; required fixture tool: pier head die;

Specific operations: First, the pier head die with the corresponding size is installed on the puncher, and the upper and lower stroke positions are adjusted according to size requirements. And then, starting the device, the head of the profile is placed into the heating equipment for heating, and keep heating until the head turns red and bright and a slight oxidation appears on the surface. Next, the head of the profile is put into the pier head die for stamping, to make the head of the profile bigger and thicker, so as to achieve the required head size.

(3) Forging and Pressing:

The name of the required equipment: Friction pressing machine and heating equipment; required fixture tool: hot forging die;

Specific operations: first, the hot forging die with the corresponding size is installed on the friction pressing machine. And then, starting the device, the entire profile is placed into the heating equipment for heating until the head turns red and bright and a slight oxidation appears on the surface. Next, the heated profile is put into the hot forging die to be forged and pressed for forming processing, so as to achieve the outer surface dimension.

(4) Edge Cutting:

The name of the required equipment name: puncher; required fixture tool: cutting edge die;

The cutting edge die is a die integrating two processes of cutting and punching; The forged and pressed blank is cut and punched at the same time;

Specific operations: First, the cutting edge die with the corresponding size is installed on the puncher, and the upper and lower strokes are adjusted. And then, starting the device, the forge piece that is forged and pressed just now is placed into the cutting edge die for stamping processing, and the external excess waste is cut off. At the same time, the fixing screw hole and the shock absorbing hole are punched out.

(5) Polishing:

The name of the required equipment: automatic polishing machine; required fixture tool: profiling die;

Specific operations: First, the profiling die with the corresponding size is installed on the automatic polishing machine, and the position of backing is adjusted. And then, starting the device, the blank piece is put into the profiling die for polishing process, so as to achieve the required surface finish.

(6) Milling or Grinding Blade Edge:

The name of the required equipment: milling machine or grinding machine; required fixture tool: profiling die;

Specific operations: First, the profiling die with the corresponding size is installed on the milling machine or grinding machine, and the position of backing is adjusted. And then, starting the device, the blank piece is put into the profiling die for milling or grinding, so as to achieve the required blade edge size requirements.

(7) Heat Treatment:

The name of the required equipment: Mesh belt furnace

Specific operations: First, heating is conducted. The temperature is raised to be 850°±10° C. The temperature is set according to the requirements of the material. The heating time is 45 minutes, then the cooling is conducted by high-speed quenching oil and the cooling rate is 100° C./sec. Finally, tempering is conducted, the tempering temperature is 260°±10° C., and the tempering time is 1.5 hours or more, so as to achieve the required hardness requirements.

(8) Retreating Handle:

The name of the required equipment: heating equipment;

As the percussion hardness of the end portion after the heat treatment is too high, so the retreating handle is needed to be conducted on the end portion.

Specific operations: The induction coil with the corresponding size is installed on the heating equipment. Opening the equipment, the end portion is put into the induction coil for heating for 5 s, and then the end portion is removed and the natural cooling is conducted, so as to achieve the required hardness requirements of the end portion.

(9) Sand Blasting:

The name of the required equipment: Automatic sand blasting machine;

Specific operations: It is placed into the automatic sand blasting machine for sand blasting process, and the processing time is 25-30 minutes, so as to achieve the required surface roughness requirements.

(10) Surface Treatment:

Different surface treatments are performed according to customer requirements.

Surface plastic spraying treatment: the name of the required equipment: plastic spraying platform and oven;

Specific operations: First, the appropriate oven temperature required by the plastic powder is pre-set, and they are in turn hung on the plastic spraying line.

When entering the plastic spraying platform, the staff will spray uniform plastic powder on its surface layer, having a required thickness of 0.07-0.15 mm on a single side. And then, it flows out of the plastic spraying platform through the assembly line, and then goes through the oven for baking. Next, it goes out of the oven, then goes through the assembly line for automatically cooling, and flows to the end. The temperature is within 20°, and then it is removed, and the rust-proof treatment is conducted on the head.

(11) Assembly:

The name of the required equipment: Automatic rotary screwdriver and vertical assembler; required fixture tool: profiling die;

After the above 10 processes, the iron main body has reached the finished product requirements. The upper and lower plastics composite blocks are fitted in the groove of the iron main body after two injection moldings. And then, two fixing hexagonal screws are added and tightened by the automatic rotary screwdriver. Next, the iron main body is placed into the profiling die of the vertical assembler, and the end portion is fitted into the protective ring. Finally, the protective ring is compressed by the vertical assembler.

This structure has the following features: The main body is an iron main body, and the grab handle portion and the rod are integrally designed. The grip sense is not restricted by the rod. The iron main body is provided with two screw fixing holes at the front position of the main body, and a shock absorbing hole is provided before the percussion position of the end portion. The two sides of the grab handle are respectively provided with three finger grooves, which are designed to be fitted with the hand. And the shape, curve, texture and structure of the grab handle of the iron main body can vary depending on the tool requirements. The plastic composite blocks are injection molded from a kind of hard rubber and a kind of soft rubber. The shape and the structure of the plastic composite blocks change with the iron main body, and the texture of the surface can be changed individually. The plastic composite blocks are fixed on the iron main body by screws. According to the needs of different tools, one, two, three or more, fixing screws can be used. The protective ring is fixed at the groove position at the end of the iron main body by a strong pressure. And the shape of the protective ring can also be changed according to requirements. The shape of the protective ring can become smaller or larger, can also become hexagonal, oval and circular and so on. Each part can be freely disassembled and replaced, or the iron main body can also be used singularly.

The advantages are: The tool has a combined integral design, with two screw holes, which can effectively prevent the handle from sliding up and down in the percussion process. The shock absorbing hole at the end of the main body can effectively reduce the vibration of the product in the percussion process. The two upper and lower plastic composite blocks at the grab handle position of the main body and the protective ring at the end of the main body can be freely assembled and disassembled. The two upper and lower plastic composite blocks and the protective ring can be used in combination or can also be used separately. The plastic parts can also be disassembled and replaced when the plastic parts are broken. Each side of the grab handle is provided with three finger grooves, and thus the grab handle fits a hand and has a better grip sense, effectively preventing the tool from slipping off when the tool is being used.

Therefore, the present invention provides a combined integral chisel having high efficiency, which is compact in structure and excellent in performance and improves operational safety performance.

### BRIEF DESCRIPTION OF THE DRAWINGS

FIG. 1 is a schematic structural view of a main body of the present invention;

FIG. 2 is a schematic side view of FIG. 1;

FIG. 3 is a schematic view showing the structure with a plastic handle mounting plate and a protective ring added according to the present invention;

FIG. 4 is an explosive view of the structure of FIG. 3;

FIG. 5 is a sectional view of the structure of FIG. 3.

### DETAILED DESCRIPTION OF THE EMBODIMENTS

The technical solutions of the present invention will be further described in detail with reference embodiments and the accompanying drawings.

### Embodiments

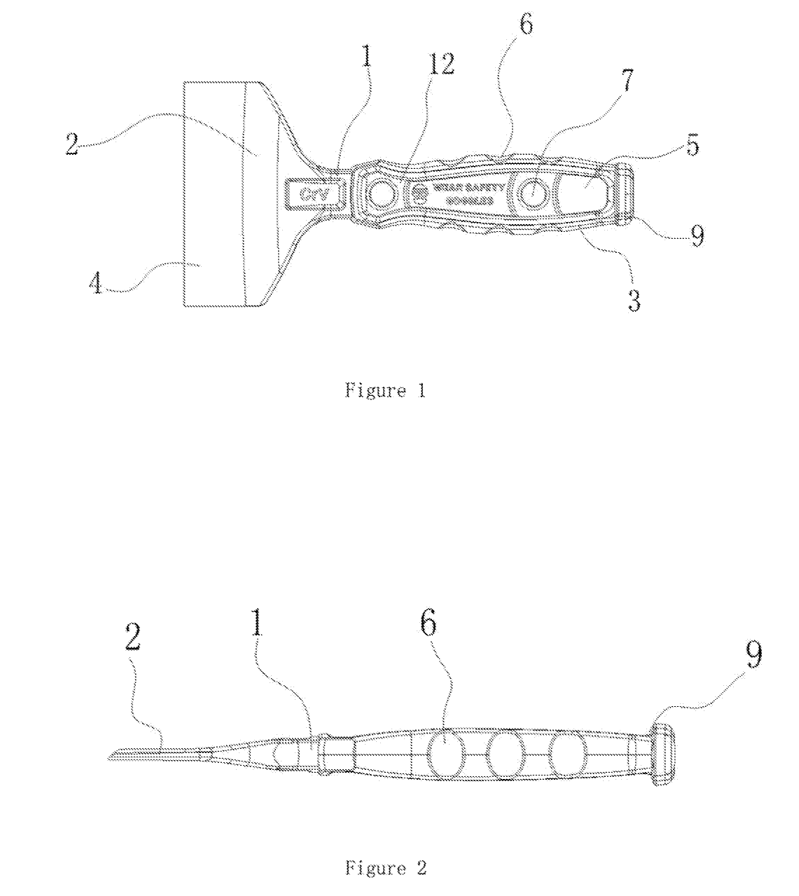

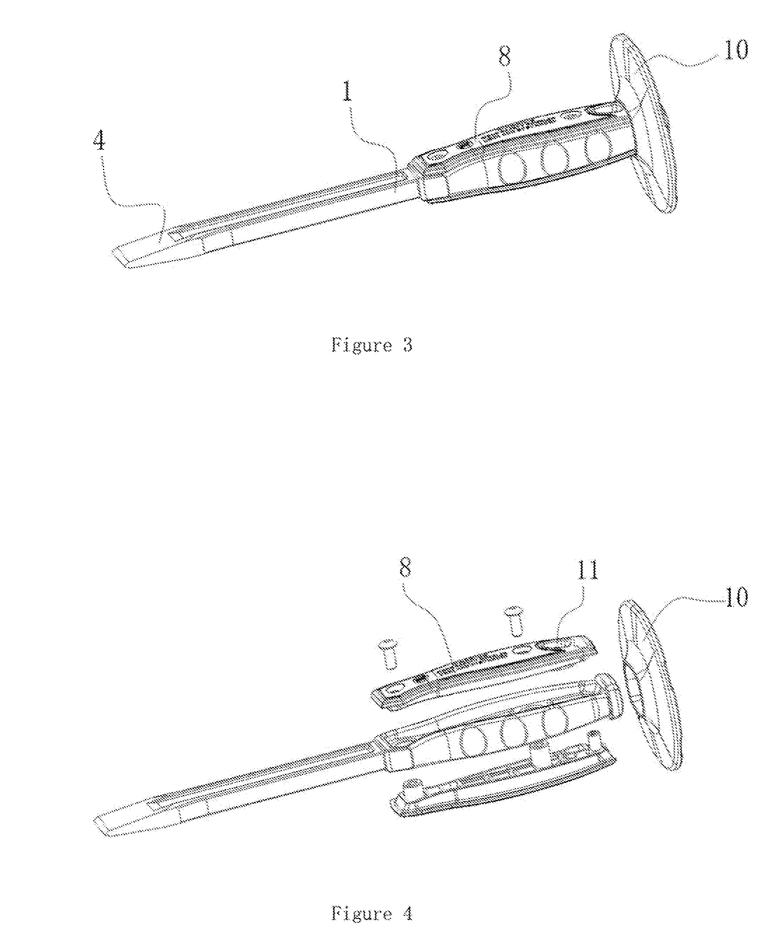

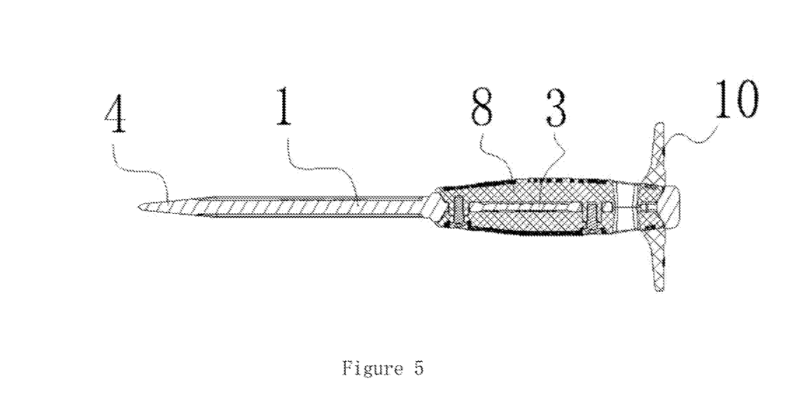

As shown in FIG. 1, FIG. 2. FIG. 3, FIG. 4 and FIG. 5, a combined integral chisel having high efficiency includes main body 1. A head portion of main body 1 is chisel head portion 2, an end portion of main body 1 is grab handle portion 3. Chisel head portion 2, main body 1 and grab handle portion 3 are integrally distributed.

The outer end of chisel head portion 2 is chisel head 4.

Chisel head portion 2 is divided into a wide chisel and a point chisel, the angle of chisel head 4 is within 30 degrees to 90 degrees.

The end of grab handle portion 3 is provided with shock absorbing hole 5, and two sides of grab handle portion 3 are respectively provided with a plurality of finger grooves 6.

Grab handle portion 3 is provided with a pair of plastic handle mounting holes 7 spaced with each other. Plastic handle mounting plates 8 are respectively arranged at a top portion and a bottom portion of the grab handle portion 3. Two plastic handle mounting plates 8 are assembled and positioned by plastic handle mounting holes 7.

The end of grab handle portion 3 is protective ring mounting portion 9, and protective ring mounting portion 9 is provided with protective ring 10.

The end of plastic handle mounting plate 8 is provided with shock absorbing through hole 11, wherein shock absorbing through hole 11 is connected to the shock absorbing hole 5. Protective ring 10 is assembled by two semicircular protective sheets, wherein a diameter of protective ring 10 is bigger than a width of grab handle portion 3. Two plastic handle mounting plates 8 are fixed to grab handle portion 3 by a bolt.

A surface of plastic handle mounting plate 8 is a soft material, an interior part of plastic handle mounting plate 8 is hard material.

Grab handle portion 3 is provided with mounting slot 12 for the plastic handle mounting plate, and plastic handle mounting plate 8 is embedded into mounting slot 12 for the plastic handle mounting plate.

What is claimed is:

1. A combined integral chisel having high efficiency, comprising: a main body, wherein a head portion of the main body is a chisel head portion, an end portion of the main body is a grab handle portion, the chisel head portion, the main body and the grab handle portion are integrally distributed;
an outer end of the chisel head portion is a chisel head.

2. The combined integral chisel having high efficiency according to claim 1, wherein the chisel head portion is divided into a wide chisel and a point chisel, an angle of the chisel head is within 30 degrees to 90 degrees;
an end of the grab handle portion is provided with a shock absorbing hole, and two sides of the grab handle portion are respectively provided with a plurality of finger grooves.

3. The combined integral chisel having high efficiency according to claim 1, wherein the grab handle portion is provided with a pair of plastic handle mounting holes spaced from each other, wherein two plastic handle mounting plates are respectively arranged at a top portion and a bottom portion of the grab handle portion, and the two plastic handle mounting plates are assembled and positioned by the plastic handle mounting holes;
an end of the grab handle portion is a protective ring mounting portion, and the protective ring mounting portion is provided with a protective ring.

4. The combined integral chisel having high efficiency according to claim 3, wherein an end of each plastic handle mounting plate is provided with a shock absorbing through hole, wherein the shock absorbing through hole is connected to the shock absorbing hole;
the protective ring is assembled by two semicircular protective pieces, wherein a diameter of the protective ring is bigger than a width of the grab handle portion, and the two plastic handle mounting plates are fixed to the grab handle portion by a bolt.

5. The combined integral chisel having high efficiency according to claim 3, wherein a surface of each plastic handle mounting plate is a soft material, an interior part of the each plastic handle mounting plate is hard material.

6. The combined integral chisel having high efficiency according to claim 3, wherein the grab handle portion is provided with a mounting slot for each plastic handle mounting plate, and the each plastic handle mounting plate is embedded into the mounting slot for the each plastic handle mounting plate.
